(19) United States
(12) Patent Application Publication
(10) Pub. No.: US 2023/0093386 A1
(43) Pub. Date: Mar. 23, 2023

(54) COMPOSITE MATERIAL PROCESSING APPARATUS AND COMPOSITE MATERIAL PROCESSING METHOD

(71) Applicant: MITSUBISHI HEAVY INDUSTRIES, LTD., Tokyo (JP)

(72) Inventors: Saneyuki GOYA, Tokyo (JP); Junichiro MIYAGAKI, Tokyo (JP); Jiro YONEDA, Tokyo (JP); Ryuichi NARITA, Tokyo (JP); Hirotoshi TAGATA, Tokyo (JP)

(21) Appl. No.: 17/866,949

(22) Filed: Jul. 18, 2022

(30) Foreign Application Priority Data
Sep. 21, 2021 (JP) 2021-153139

(51) Int. Cl. B23K 26/38

(52) U.S. Cl. CPC B23K 26/38

(57) ABSTRACT

An object is to improve the quality of a processed composite material without reducing the processing rate. A processing apparatus includes a laser head configured to irradiate a front face of a composite material with a laser beam and a gas supply unit configured to supply an assist gas to an irradiation point irradiated with the laser beam by the laser head. The gas supply unit has a first-level nozzle configured to eject the assist gas to an area at or near the irradiation point and a second nozzle configured to eject the assist gas to an area at or near the irradiation point and arranged above the first-level nozzle. The angle of the direction in which the first-level nozzle ejects the assist gas relative to the front face differs from the angle of the direction in which the second nozzle ejects the assist gas relative to the front face.

### CROSS-REFERENCE TO RELATED APPLICATIONS

This application claims the benefit of priority to Japanese Patent Application Number 2021-153139 filed on Sep. 21, 2021. The entire contents of the above-identified application are hereby incorporated by reference.

### BACKGROUND OF THE INVENTION

### 1. Field of the Invention

The present disclosure relates to a composite material processing apparatus and a composite material processing method.

### 2. Description of Related Art

A composite material such as thermosetting carbon fiber reinforced plastic (CFRP) may be used in aircraft components such as a fuselage and a main wing of an aircraft, for example. As a method for processing such a thermosetting composite material into a desired shape, a method of irradiating a composite material with a laser beam to cut the composite material is known (for example, Japanese Patent No. 6719231).

Japanese Patent No. 6719231 discloses a processing apparatus including a laser beam source unit configured to output a laser beam, a stage on which CFRP that is a plate-like carbon fiber composite material is placed, and a plurality of gas nozzles supplied with a nitrogen gas, which is a non-oxidization gas, from a gas supply apparatus. The gas nozzles are arranged in series along a planned cut line on one of the front face sides of the CFRP. More specifically, each gas nozzle is arranged at an inclination of a predetermined angle with respect to the front face. In this processing apparatus, a nitrogen gas is blown onto a part irradiated with a laser beam (on and near the planned cut line) from the plurality of gas nozzles at the same time as laser beam irradiation.

Japanese Patent No. 6719231 is an example of the related art.

### BRIEF SUMMARY OF THE INVENTION

In Japanese Patent No. 6719231, however, a relatively thin composite material (CFRP) having a thickness of 2 mm is cut by a processing apparatus. Thus, in Japanese Patent No. 6719231, it is not assumed to cut a relatively thick composite material having a thickness of, for example, 20 mm or the like.

Further, in the processing apparatus of Japanese Patent No. 6719231, a plurality of gas nozzles are arranged in series along a planned cut line. Thus, respective gas nozzles have the same inclination angle. Therefore, gas (nitrogen gas) ejected from the gas nozzles may unevenly flow inside a groove formed in a process of cutting the composite material (CFRP). In particular, cutting a thick composite material will involve a deeper groove formed in the cutting process. Thus, the gas is less likely to flow deep inside the groove, and this may cause an uneven gas flow inside the groove.

Such an uneven gas flow inside the groove will reduce a cooling effect by the gas. With such a reduction in the cooling effect by the gas, a resin contained in the composite material may be damaged by heat due to thermal influence during laser beam irradiation, and this may lead to a reduction in the quality of the processed composite material. Further, with an uneven gas flow inside the groove, it may not be possible to effectively discharge fumes, which occurs during cutting of the composite material, out of the groove. If fumes are not discharged out of the groove, these fumes will interfere with a laser beam, and processing will not be suitably applied, which may lead to a reduction in the quality of the processed composite material or a reduction in the processing speed.

The present disclosure has been made in view of such circumstances and intends to provide a composite material processing apparatus and a composite material processing method that can improve the quality of a processed composite material.

Further, the present disclosure intends to provide a composite material processing apparatus and a composite material processing method that can improve the quality of a processed composite material without reducing the processing speed even when cutting a relatively thick composite material.

To achieve the above objects, the composite material processing apparatus and the composite material processing method of the present disclosure employ the following solutions.

A composite material processing apparatus according to one aspect of the present disclosure is a composite material processing apparatus for cutting, along a planned cut line, a composite material in which fibers and a resin are compounded and includes: an irradiation unit configured to irradiate a front face of the composite material with a laser beam; and a gas supply unit configured to supply a gas to an irradiation point that is a point irradiated with the laser beam by the irradiation unit. The gas supply unit has a first ejection unit configured to eject the gas to an area at or near the irradiation point and a second ejection unit configured to eject the gas to an area at or near the irradiation point and arranged above the first ejection unit, and an angle between a direction in which the first ejection unit ejects the gas and the front face of the composite material differs from an angle between a direction in which the second ejection unit ejects the gas and the front face of the composite material.

A composite material processing method according to one aspect of the present disclosure is a composite material processing method for applying processing to a composite material in which fibers and a resin are compounded and includes: by an irradiation unit, irradiating the composite material with a laser beam; and by a first ejection unit and a second ejection unit arranged above the first ejection unit, ejecting a gas to an area at or near an irradiation point irradiated with the laser beam by the irradiation unit. An angle between a direction in which the first ejection unit ejects the gas and the front face of the composite material differs from an angle between a direction in which the second ejection unit ejects the gas and the front face of the composite material.

According to the preset disclosure, it is possible to improve the quality of a processed composite material without reducing the processing speed.

Further, it is possible to improve the quality of a processed composite material even when cutting a relatively thick composite material.

### BRIEF DESCRIPTION OF THE SEVERAL VIEWS OF THE DRAWINGS

FIG. 1 is a schematic configuration diagram of a processing apparatus according to an embodiment of the present disclosure.

FIG. 2 is a schematic front view of an assist gas supply unit according to the embodiment of the present disclosure.

FIG. 3 is a graph illustrating the distance from the bottom face and the gas flow speed in a groove according to the embodiment of the present disclosure.

FIG. 4 is a perspective view illustrating a first nozzle or a second nozzle according to a modified example of the present disclosure.

FIG. 5 is a perspective view illustrating a first nozzle or a second nozzle according to a modified example of the present disclosure.

### DETAILED DESCRIPTION OF THE INVENTION

One embodiment of a composite material processing apparatus and a composite material processing method according to the present disclosure will be described below with reference to the drawings.

A processing apparatus 10 according to the present embodiment is an apparatus that cuts a large composite material 1 to manufacture an aircraft component forming an aircraft structure. Examples of the composite material 1 to be processed includes carbon fiber reinforced plastic (CFRP) in which a thermosetting resin and fibers are compounded. Specifically, the composite material 1 may be a laminated body of a multi-layered fiber reinforced sheets in which a resin is impregnated into fibers. Note that the composite material 1 may be a composite material in which fibers and a resin are compounded and is not limited to thermosetting carbon fiber reinforced plastic. For example, the composite material 1 may be a thermoplastic composite material.

In the present embodiment, the thickness of the composite material 1 is about 20 mm as an example. Note that the thickness of the composite material 1 is an example and is not limited to 20 mm. The composite material 1 may be thinner than 20 mm or may be thicker than 20 mm. As described later, however, it is more preferable to use the processing apparatus 10 of the present embodiment when cutting a relatively thick composite material 1 having a thickness of 20 mm or greater.

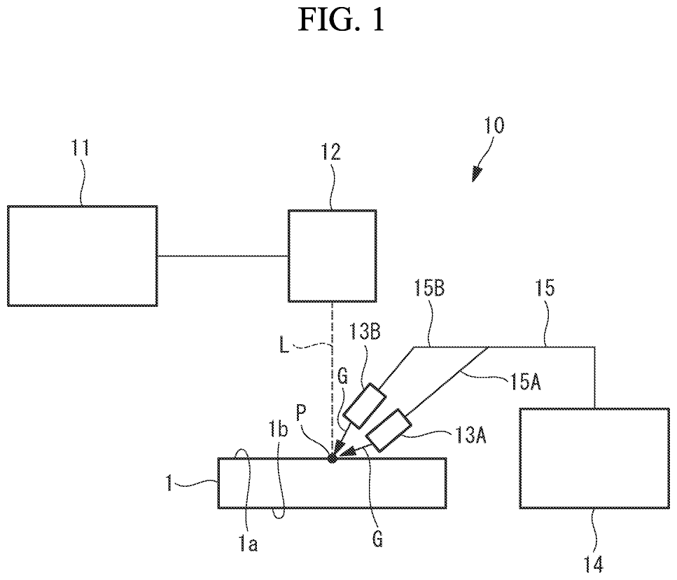

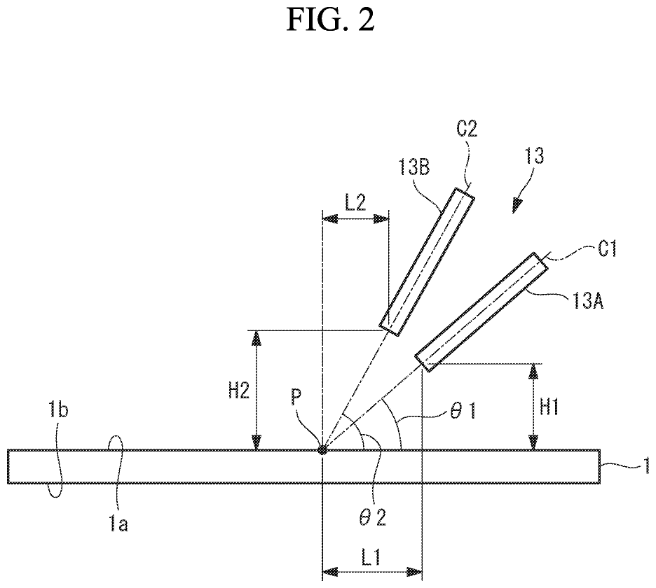

As illustrated in FIG. 1, the processing apparatus 10 includes a laser oscillator 11 that outputs a laser beam L, a laser head (irradiation unit) 12 that irradiates the composite material 1 with the laser beam L output from the laser oscillator 11, and an assist gas supply unit (gas supply unit) 13 that supplies an assist gas G to an irradiation point P (see FIG. 2), and an assist gas source 14 that supplies the assist gas G to the assist gas supply unit 13. The processing apparatus 10 cuts the plate-like composite material 1 placed on a stage (not illustrated) along a planned cut line. In the present embodiment, the planned cut line is a line extending in a lateral direction in the drawing sheet of FIG. 1 and FIG. 2.

The laser oscillator 11 outputs a high-power continuous wave laser beam L, for example. The laser beam L output from the laser oscillator 11 is guided to the laser head 12.

The laser head 12 irradiates an irradiation point P (a focal point on which the laser beam L is focused) with the laser beam L. The irradiation point P is provided on the planned cut line. The laser head 12 emits the laser beam L to the front face 1a of the composite material 1, which is a member to be processed, and processes the composite material 1. Specifically, the composite material 1 is irradiated with the laser beam L, and thereby the composite material 1 is cut along the planned cut line. For example, the laser head 12 is formed of a Galvano scanner and has a Galvano mirror (not illustrated) that is a planar mirror and a drive motor (not illustrated) that swings the mirror surface of the Galvano mirror. The laser head 12 is configured to reflect the input laser beam L by the Galvano mirror and emit the reflected laser beam L to any position on the front face 1a of the composite material 1. Note that the specific configuration of the laser head 12 may be any configuration as long as a desired function can be achieved and is not limited to the configuration described above.

The distance between the laser head 12 and the composite material 1 (specifically, the irradiation point P) is about 600 mm.

As illustrated in FIG. 1 and FIG. 2, the assist gas supply unit 13 includes a first nozzle (first ejection unit) 13A configured to eject an assist gas G (air in the present embodiment) to the irradiation point P and a second nozzle (second ejection unit) 13B configured to eject the assist gas G (air in the present embodiment) to the irradiation point P and arranged above the first nozzle 13A. Note that the position to which the assist gas G is ejected by the first nozzle 13A and the second nozzle 13B is not required to be the exact irradiation point P and may be an area at or near the irradiation point P.

The area at or near the irradiation point P refers to a range where the first nozzle 13A and the second nozzle 13B eject the assist gas G so that a predetermined function of the first nozzle 13A and the second nozzle 13B can be performed. The predetermined function of the first nozzle 13A and the second nozzle 13B may be, for example, a function of causing the assist gas G to flow into a groove formed in the front face 1a of the composite material 1 by irradiation of the irradiation point P with the laser beam L, a function of removing fumes occurring due to irradiation with the laser beam L, or the like. Further, the area at or near the irradiation point P may be a range within a radius of several millimeters (for example, 3 mm) about the irradiation point P, for example.

The first nozzle 13A is provided on the front face 1a side of the composite material 1. Further, the second nozzle 13B is provided on the front face 1a side of the composite material 1.

The first nozzle 13A and the second nozzle 13B are cylindrical members about the center axis C1 and the center axis C2, respectively, and the assist gas G flows through the inside thereof. The first nozzle 13A and the second nozzle 13B eject the assist gas G from openings formed at the tip. The inside of the first nozzle 13A and the second nozzle 13B may have so-called Laval nozzle structure in which a smaller diameter part and a larger diameter part are arranged continuously in the flow direction of the assist gas G, for example. Such a structure enables ejection of the assist gas G over the speed of sound. Note that the structure of the first nozzle 13A and the second nozzle 13B may each be any structure as long as it can eject the assist gas G to the irradiation point P and is not limited to the configuration described above. For example, the first nozzle 13A and the second nozzle 13B may each be a circular tube nozzle.

As illustrated in FIG. 2, the first nozzle 13A is arranged such that the direction of ejection of the assist gas G (see FIG. 1) and the front face 1a of the composite material 1 form a predetermined angle θ1. In other words, the first nozzle 13A is arranged such that the extension line of the center axis C1 and the front face 1a of the composite material 1 form a predetermined angle θ1 (hereafter, referred to as “inclination angle θ1”). In the present embodiment, the inclination angle θ1 is 40 degrees.

Further, the second nozzle 13B is arranged such that the direction of ejection of the assist gas G (see FIG. 1) and the front face 1a of the composite material 1 form a predetermined angle θ2. In other words, the second nozzle 13B is arranged such that the extension line of the center axis C2 and the front face 1a of the composite material 1 form a predetermined angle θ2 (hereafter, referred to as “inclination angle θ2”). In the present embodiment, the inclination angle θ2 is 60 degrees.

In such a way, the inclination angle θ1 of the first nozzle 13A and the inclination angle θ2 of the second nozzle 13B differ from each other. Specifically, the inclination angle θ2 of the second nozzle 13B is larger than the inclination angle θ1 of the first nozzle 13A.

In the present embodiment, the height H1 of the tip of the first nozzle 13A (the height to the front face 1a of the composite material 1) is 30 mm. When the front face 1a of the composite material 1 is viewed in a plan view (hereafter, simply referred to as “in plan view”), the distance L1 between the tip of the first nozzle 13A and the irradiation point P is 40 mm.

Further, the height H2 of the tip of the second nozzle 13B (the height to the front face 1a of the composite material 1) is 40 mm. Further, in plan view of the front face 1a of the composite material 1, the distance L2 between the tip of the second nozzle 13B and the irradiation point P is 30 mm.

Note that the specific numerical values of an ejection amount, an angle, a height, a distance described above are mere examples and are not limited to the numerical values described above.

The first nozzle 13A and the second nozzle 13B are arranged so as to overlap each other in plan view. Thus, the first nozzle 13A and the second nozzle 13B eject the assist gas G to the irradiation point P from the same direction in plan view.

The assist gas source 14 supplies the assist gas G to the assist gas supply unit 13. Specifically, the assist gas source 14 supplies the assist gas G to the first nozzle 13A and the second nozzle 13B via an assist gas pipe 15. The upstream end of the assist gas pipe 15 is connected to the assist gas source 14. Further, the assist gas pipe 15 is branched into a first assist gas pipe 15A and a second assist gas pipe 15B at an intermediate position. The downstream end of the first assist gas pipe 15A is connected to the first nozzle 13A. Further, the downstream end of the second assist gas pipe 15B is connected to the second nozzle 13B.

Next, a method of cutting the composite material 1 using the processing apparatus 10 will be described.

First, the laser beam L is output from the laser oscillator 11. Subsequently, the laser beam L is guided to the laser head 12. Subsequently, the laser beam L is emitted by the laser head 12 along the planned cut line of the composite material 1 (in an irradiation step). Thus, the laser beam L is emitted so that the irradiation point P is located to overlap the planned cut line. Next, the planned cut line is scanned by the laser beam L for multiple times. As a result, the front face 1a of the composite material 1 is scraped by the energy of the laser beam L, and a groove is formed along the planned cut line. Subsequently, the laser beam L is emitted to the bottom face of the groove to scan multiple times, and thereby the bottom face of the groove is scraped, and thereby the groove is deepened. The depth of the groove is increased stepwise by repetition of the above operation, and the composite material 1 is finally cut.

Further, at the same time as emission of the laser beam L to the composite material 1, the assist gas G is ejected to the part irradiated with the laser beam L (at and/or near the irradiation point P) by the first nozzle 13A and the second nozzle 13B (in an ejection step).

Details of a method of emitting the laser beam L and a method of ejecting the assist gas G will be described.

In the present embodiment, every time a predetermined number of times of scans with the laser beam L are performed, the irradiation point P is moved by a predetermined distance in the plate thickness direction of the composite material 1. Specifically, the irradiation point P is moved by a predetermined distance in the direction of the back face 1b (the face on the opposite side of the front face 1b) of the composite material 1. Further, in response to the movement of the irradiation point P, the ejection target point (supply point) of the assist gas G in the first nozzle 13A and the second nozzle 13B are also moved by a predetermined distance in the direction of the back face 1b so as to follow the moving irradiation point P.

Specifically, it is conceivable that the irradiation point P is moved by about 2 mm for every five reciprocal scans with the laser beam L, for example. Further, the ejection target point (supply point) of the assist gas G in the first nozzle 13A and the second nozzle 13B are also moved by a length of one-tenth of the plate thickness of the composite material 1 so as to follow the moving irradiation point P. In such a case, it is possible to cut the composite material 1 by performing 10 sets of 5 reciprocal scans with the laser beam L.

The movement of the irradiation point P of the laser beam L and the movement of the ejection target point of the assist gas G in the first nozzle 13A and the second nozzle 13B may be performed by a control device or may be performed manually.

The control device is formed of a central processing unit (CPU), a random access memory (RAM), a read only memory (ROM), a computer readable storage medium, and the like, for example. Further, a series of processes for implementing various functions are stored in the storage medium or the like in a form of a program as an example, and various functions are implemented when the CPU reads such a program to the RAM or the like and performs modification or operational processing on information. Note that a form in which a program is installed in advance in a ROM or another storage medium, a form in which a program is provided in a state of being stored in a computer readable storage medium, a form in which a program is delivered via a wired or wireless communication scheme, or the like may be applied to the program. The computer readable storage medium may be a magnetic disk, a magneto-optical disk, a CD-ROM, a DVD-ROM, a semiconductor memory, or the like.

Note that the configuration of the control device is not limited to the configuration described above.

According to the present embodiment, the following effects and advantages are achieved.

In the present embodiment, the first nozzle 13A configured to eject the assist gas G to the irradiation point P and the second nozzle 13B provided above the first nozzle 13A are provided. Further, the angle between the direction in which the first nozzle 13A ejects the assist gas G and the front face 1a of the composite material 1 (inclination angle θ1) and the angle between the direction in which the second nozzle 13B ejects the assist gas G and the front face 1a of the composite material 1 (inclination angle θ2) differ from each other. In such a way, nozzles having different angles are provided vertically in two levels. The assist gas G flows into a groove formed in the composite material 1 in a process of cutting the composite material 1. With nozzles provided at two levels, variation in the flow rate of the assist gas G can be reduced inside the groove. More specifically, the flow rate of the assist gas G over respective height positions can be evenly distributed between the bottom of the groove to the upper end of the groove. In particular, when the thick composite material 1 is cut, the assist gas G is less likely to flow into the groove because of the increased depth of the groove formed in the cutting process, and variation in the flow rate of the assist gas G is likely to occur inside the groove. Even in such a case, variation in the flow rate of the assist gas G can be reduced inside the groove according to the present embodiment.

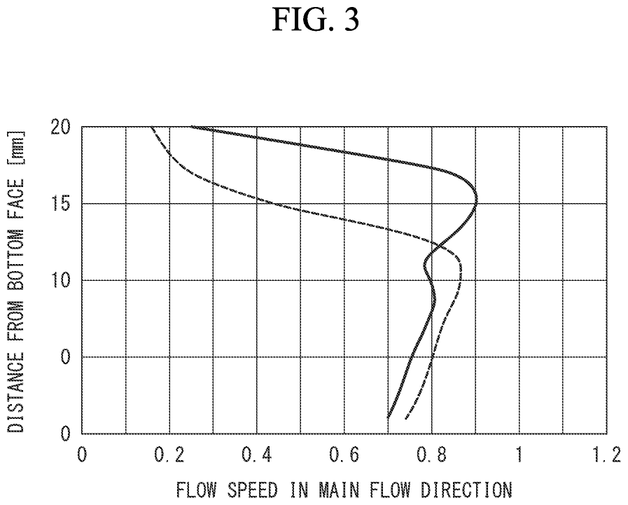

The effect of the assist gas G being evenly distributed will be described in detail with reference to FIG. 3. FIG. 3 illustrates data of a result of analysis from a simulation, which is a flow speed distribution when the laser irradiation position (irradiation point P) is viewed in the perpendicular direction. The vertical axis of FIG. 3 represents the distance (mm) from the bottom face of the groove. Further, the horizontal axis represents a flow speed in the main flow direction of the assist gas G, which represents a ratio when the highest flow speed is defined as 1. Note that, in the present embodiment, the flow of the assist gas G in a direction along the cut line (groove) is defined as the main flow direction of the assist gas G. Further, the solid line in FIG. 3 indicates a case where nozzles vertically provided at two levels eject the assist gas G, and the dashed line indicates a case where a nozzle provided at a single level ejects the assist gas G. Note that the total flow rate of the assist gas to be ejected is the same between the case of nozzles vertically provided at two levels and the case of a nozzle provided at a single level.

As can be seen from FIG. 3, when the assist gas G is ejected by the nozzles vertically arranged at two levels as with the present embodiment, the flow speed in the main flow direction of the assist gas G is relatively higher even in a region distant from the bottom face (that is, the front face side of the composite material 1). In particular, the flow speed in the main flow direction of the assist gas G is relatively higher even in a region distant by 15 mm to 20 mm from the bottom face. It can be seen that, because of such an increased flow rate, the flow rate of the assist gas G over respective height positions is evenly distributed in the groove compared to the case where the nozzle provided at a single level ejects the assist gas G.

With the reduced variation in the flow rate of the assist gas G inside the groove, a cooling effect works evenly, and thermal influence during irradiation with the laser beam L can be reduced. Thus, the quality of the processed composite material 1 can be improved. Further, since the flow rate of the assist gas G flowing into the groove can be evenly distributed, fumes occurring during cutting of the composite material 1 can be effectively discharged out of the groove. Thus, interference between fumes and the laser beam L is reduced, and the composite material 1 can be suitably processed. Therefore, the quality of the processed composite material 1 can be improved.

Further, in the present embodiment, thermal influence during laser irradiation can be reduced, and interference between fumes and the laser beam L can be reduced. Accordingly, the laser beam L with higher energy (for example, a continuous wave laser beam) can be emitted to the composite material 1, and the amount of scraping the composite material 1 by one-time irradiation with the laser beam L can be increased. Thus, the depth of the groove resulted from one-time irradiation with the laser beam L can be increased. Accordingly, the number of times of irradiation required for a cutting operation can be reduced. Therefore, the processing speed can be increased, and the time required for processing can be shortened.

Further, since air is used as the assist gas G in the present embodiment, cost can be reduced compared to a case where a special gas such as an inert gas is used as the assist gas G, for example.

Further, in the present embodiment, in the assist gas supply unit 13, the ejection target point where to supply the assist gas G can be moved in accordance with the movement of the irradiation point P. Accordingly, for example, when a thick composite material 1 is cut and even when the irradiation point P is moved in the plate thickness direction of the composite material 1, the assist gas G can be accurately supplied to the irradiation point P. Therefore, the composite material 1 can be suitably processed.

Note that the present disclosure is not limited to each embodiment described above, and modifications are possible as appropriate within the scope not departing from the spirit of the present disclosure.

[Modified Example 1]

For example, although an example in which each of the first nozzle 13A and the second nozzle 13B is a cylindrical member has been described in the above embodiment, the present disclosure is not limited thereto.

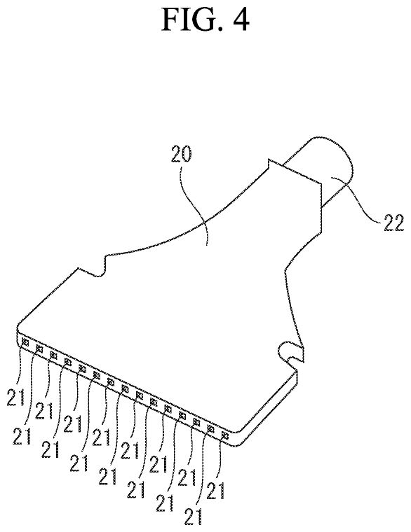

For example, as illustrated in FIG. 4, the first nozzle 13A and the second nozzle 13B may each be a flat nozzle 20 in which a plurality of openings 21 for ejecting the assist gas G are formed at the tip. The plurality of openings 21 are aligned at predetermined intervals along the planned cut line. The assist gas G ejected from each opening 21 spreads and merges with the assist gas G ejected from an adjacent opening. Thus, the assist gas G will be ejected in a plane extending along the planned cut line from the flat nozzle 20. Therefore, the assist gas G can be ejected to a region extending along the planned cut line.

Further, a cylindrical part 22 connected to the first nozzle 13A and/or the second nozzle 13B is provided to the base end of the flat nozzle 20.

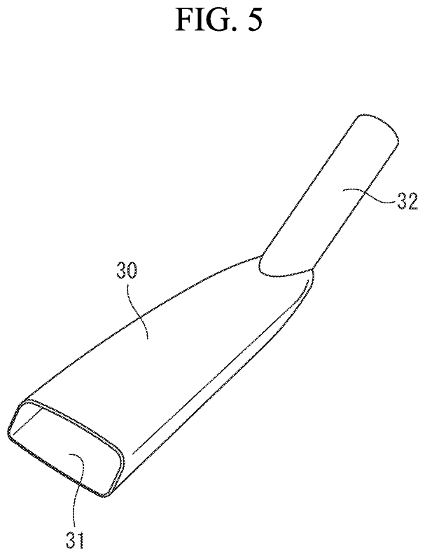

Further, as illustrated in FIG. 5, the first nozzle 13A and/or the second nozzle 13B may be a flat nozzle 30 in which an opening 31 for ejecting the assist gas G is formed at the tip.

The opening 31 has substantially a rectangular shape, and the longer side thereof is formed so as to extend along the planned cut line. Thus, the assist gas G will be ejected in a plane extending along the planned cut line from the flat nozzle 30. Therefore, the assist gas G can be ejected to a region extending along the planned cut line.

Further, a cylindrical part 32 connected to the first nozzle 13A and/or the second nozzle 13B is provided to the base end of the flat nozzle 30.

In the present modified example, the first nozzle 13A and/or the second nozzle 13B ejects the assist gas G to a region extending along the planned cut line. This can make it easier for a gas to flow into a groove formed along the planned cut line. Therefore, the amount of a gas flowing into a groove can be increased. Thus, the cooling effect by the gas works more effectively, and thermal influence during irradiation with the laser beam L can be further reduced. Further, fumes can be effectively discharged out of the groove. Therefore, the quality of the processed composite material 1 can be improved.

[Modified Example 2]

Further, the ejection target point of the assist gas G ejected from the assist gas supply unit 13 may be shifted vertically or laterally.

The way of shifting the ejection target point is not particularly limited. For example, the assist gas supply unit 13 may have a tip movement mechanism (not illustrated) that moves the tips of the first nozzle 13A and the second nozzle 13B vertically or laterally, and the tip movement mechanism may move the tips of the first nozzle 13A and the second nozzle 13B to shift the ejection target point. For example, the tip movement mechanism may have a gear that connects a motor and a motor shaft to each nozzle and move the tip of each nozzle by rotation and driving force of the motor.

Further, for example, the assist gas supply unit 13 may have a separate nozzle whose ejection target point is shifted vertically or laterally from the ejection target points of the first nozzle 13A and the second nozzle 13B, and the ejection target point may be shifted by switching the nozzle which ejects the assist gas G.

The inflow distribution of the assist gas G inside the groove formed in the composite material 1 is changed by shifting the ejection target point at predetermined time intervals, it is thus possible to suppress thermal influence inside the groove.

[Modified Example 3]

Further, for example, although the example in which the first nozzle and the second nozzle are provided has been described in the above embodiment, the present disclosure is not limited thereto. The number of levels of the nozzles may be three or greater. Thus, one or a plurality of nozzles (third ejection unit) having a different height position and a different inclination angle from the first nozzle and the second nozzle may be provided.

By providing three or more nozzles in such a way, it is possible to improve flexibility in the flow rate of each nozzle compared to the case of two nozzles. Therefore, variation in the flow rate of the assist gas G can be more suitably reduced inside the groove. Thus, thermal influence during irradiation with the laser beam L can be reduced. The quality of the processed composite material 1 can thus be improved.

[Modified Example 4]

Further, although the example in which the first nozzle 13A and the second nozzle 13B are arranged so as to overlap each other in plan view has been described in the above embodiment, the present disclosure is not limited thereto. For example, the first nozzle 13A and the second nozzle 13B may be arranged so as not to overlap each other in plan view. However, it is preferable that the first nozzle 13A and the second nozzle 13B be arranged within the same quadrant about the irradiation point P in plan view of the composite material 1. In other words, it is preferable that the first nozzle 13A and the second nozzle 13B be arranged such that the angle formed between directions of ejection of the assist gas G is within 90 degrees in plan view.

If the first nozzle 13A and the second nozzle 13B are arranged in different quadrants, then the first nozzle 13A and the second nozzle 13B will be arranged so as to interpose the irradiation point P and will eject the assist gas G toward the irradiation point P from the opposite directions. In such a case, the assist gas G ejected from the first nozzle 13A and the assist gas G ejected from the second nozzle 13B collide with each other and may generate an updraft. If an updraft occurs, fumes occurring during cutting of the composite material 1 may rise and interfere with the laser beam L, and the composite material 1 may not be suitably processed.

On the other hand, with the first nozzle 13A and the second nozzle 13B being arranged within the same quadrant, the assist gas G ejected from the first nozzle 13A and the assist gas G ejected from the second nozzle 13B will flow in the same direction. Accordingly, no updraft occurs, and fumes can be less likely to rise. Therefore, interference between fumes and the laser beam L can be reduced, and the composite material 1 can be suitably processed.

[Modified Example 5]

Further, although the example in which air is ejected as the assist gas G from the first nozzle 13A and the second nozzle 13B has been described in the above embodiment, the present disclosure is not limited thereto. For example, an inert gas (for example, nitrogen) may be ejected as the assist gas from both the first nozzle 13A and the second nozzle 13B. Further, an inert gas may be ejected as the assist gas from either one of the first nozzle 13A and the second nozzle 13B.

With such a configuration, an inert gas is supplied to the irradiation point P of the laser beam L. Therefore, burning of a resin (base resin contained in the composite material 1) due to the energy of the laser beam L can be decreased, and thermal influence can thus be reduced.

The composite material processing apparatus and the composite material processing method described in the above embodiment are understood as follows, for example.

A composite material processing apparatus according to one aspect of the present disclosure is a composite material processing apparatus (10) for cutting, along a planned cut line, a composite material (1) in which fibers and a resin are compounded and includes: an irradiation unit (12) configured to irradiate a front face (1a) of the composite material with a laser beam (L); and a gas supply unit (13) configured to supply a gas (G) to an irradiation point (P) that is a point irradiated with the laser beam by the irradiation unit. The gas supply unit has a first ejection unit (13A) configured to eject the gas to an area at or near the irradiation point and a second ejection unit (13B) configured to eject the gas to an area at or near the irradiation point and arranged above the first ejection unit, and an angle (θ1) between a direction in which the first ejection unit ejects the gas and the front face of the composite material differs from an angle (θ2) between a direction in which the second ejection unit ejects the gas and the front face of the composite material.

In the above configuration, it is possible to cut the composite material by irradiating a composite material with a laser beam. Further, in the above configuration, the first ejection unit configured to eject a gas to an area at or near the irradiation point and the second ejection unit provided above the first ejection unit are provided. Further, the angle between the direction in which the first ejection unit ejects the gas and the front face of the composite material differs from the angle between the direction in which the second ejection unit ejects the gas and the front face of the composite material. In such a way, the ejection units having different angles are provided at two levels. When a groove is formed in the composite material in the process of cutting the composite material, the gas flows into the groove. With ejection units provided at two levels, variation in the flow rate of the gas can be reduced inside the groove. More specifically, the flow rate of the gas over respective height positions can be evenly distributed between the bottom of the groove to the upper end of the groove. In particular, when the thick composite material is cut, the gas is less likely to flow into the groove because of the increased depth of the groove formed in the cutting process, and variation in the flow rate of the gas is likely to occur inside the groove. Even in such a case, variation in the flow rate of the gas can be reduced inside the groove according to the above configuration.

With the reduced variation in the flow rate of the gas inside the groove, and thermal influence during laser beam irradiation can be reduced. Thus, the quality of the processed composite material can be improved. Further, since the flow rate of the gas flowing into the groove can be evenly distributed, fumes occurring during cutting of the composite material can be effectively discharged out of the groove. Thus, interference between fumes and the laser beam is reduced, and the composite material can be suitably processed. Therefore, the quality of the processed composite material can be improved.

Further, for example, for cutting a thick composite material, there is a case of cutting the composite material by irradiating a planned cut line with a laser beam for multiple times to scrape the planned cut line stepwise rather than cutting the composite material by one-time laser beam irradiation. More specifically, a groove is formed along a planned cut line by laser beam irradiation, and the bottom of the groove is irradiated with a laser beam to scrape the bottom and thereby deepen the groove. The depth of the groove may be increased stepwise by repetition of the above operation, and the composite material may be finally cut. The method of cutting a composite material by one-time laser beam irradiation provides a faster processing speed but suffers from larger thermal influence than the method of digging a groove by multiple-time laser beam irradiation. On the other hand, the method of digging a groove by multiple-time laser beam irradiation has an advantage that it is possible to reduce thermal influence by increasing the laser beam scanning speed. With an increased scanning speed, while a thickness that can be scraped by one-time irradiation is reduced, it is possible to cut a composite material by further digging the groove by multiple-time laser beam irradiation.

In the above configuration, as described above, the first ejection unit and the second ejection unit are provided (that is, ejection units are provided at two levels), and thereby thermal influence during laser irradiation can be reduced compared to a case of an ejection unit provided at a single level. Further, interference between fumes and a laser beam can be reduced. This enables laser beam irradiation with higher energy than in the case of an ejection unit provided at a single level. Accordingly, even when cutting the composite material by irradiating a planned cut line with a laser beam for multiple times to scrape the planned cut line stepwise, it is possible to increase the amount of scraping the composite material by one-time laser beam irradiation. Thus, the depth of the groove resulted from one-time laser beam irradiation can be increased. Accordingly, the number of times of irradiation required for a cutting operation can be reduced. Therefore, the processing speed can be increased, and the time required for processing can be shortened compared to the case of an ejection unit provided at a single level.

Note that the area at or near the irradiation point refers to a range where the first ejection unit and the second ejection unit eject a gas so that a predetermined function of the first ejection unit and the second ejection unit can be performed. The predetermined function of the first ejection unit and the second ejection unit may be, for example, a function of causing a gas to flow into a groove formed by laser beam irradiation, a function of removing fumes occurring due to laser beam irradiation, or the like. Further, the area at or near the irradiation point may be a range within a radius of several millimeters (for example, 3 mm) about the irradiation point, for example.

Further, in the composite material processing apparatus according to one aspect of the present disclosure, the first ejection unit and/or the second ejection unit ejects the gas to a region extending along the planned cut line.

In the above configuration, the first ejection unit and/or the second ejection unit ejects a gas to a region extending along the planned cut line. This can make it easier for the gas to flow into a groove formed along the planned cut line. Therefore, the amount of a gas flowing into a groove can be increased, and thermal influence during laser beam irradiation can thus be reduced. Further, fumes can be effectively discharged out of the groove. Therefore, the quality of the processed composite material can be improved.

Further, the composite material processing apparatus according to one aspect of the present disclosure includes a third ejection unit configured to eject the gas to an area at or near the irradiation point and arranged above the second ejection unit, the third ejection unit ejects the gas in a direction inclined with respect to a horizontal plane, and an angle between a direction in which the third ejection unit ejects the gas and the horizontal plane differs from angles between directions in which the first ejection unit and the second ejection unit eject the gas and the horizontal plane.

In the above configuration, the third ejection unit is provided. Thus, three ejection units are provided. It is thus possible to improve flexibility in the flow rate of each ejection unit compared to the case of two ejection units. Therefore, variation in the flow rate of the gas can be more suitably reduced inside the groove. Thus, thermal influence during laser beam irradiation can be reduced. The quality of the processed composite material can thus be improved.

Further, in the composite material processing apparatus according to one aspect of the present disclosure the gas ejected from the first ejection unit and/or the second ejection unit is an inert gas.

In the above configuration, the gas ejected from the first ejection unit and/or the second ejection unit is an inert gas. Accordingly, an inert gas is supplied to the laser beam irradiation point. Therefore, burning of a resin (base resin contained in the composite material) due to the laser beam energy can be decreased, and thermal influence can thus be reduced.

Further, in the composite material processing apparatus according to one aspect of the present disclosure, the first ejection unit and the second ejection unit are arranged in the same quadrant about the irradiation point in plan view of the composite material.

If the first ejection unit and the second ejection unit are arranged in different quadrants, then the first ejection unit and the second ejection unit will be arranged so as to interpose the irradiation point and will eject the gas toward the irradiation point from the opposite directions. In such a case, the gas ejected from the first ejection unit and the gas ejected from the second ejection unit collide with each other and may generate an updraft. If an updraft occurs, fumes occurring during cutting of the composite material may rise and interfere with the laser beam, and the composite material may not be suitably processed.

On the other hand, in the above configuration, the first ejection unit and the second ejection unit are arranged within the same quadrant about the irradiation point in plan view of the composite material. As a result, the gas ejected from the first ejection unit and the gas ejected from the second ejection unit will flow in the same direction. Accordingly, no updraft occurs, and fumes can be less likely to rise. Therefore, interference between fumes and a laser beam can be reduced, and the composite material can be suitably processed.

Further, in the composite material processing apparatus according to one aspect of the present disclosure, the irradiation unit is configured to move the irradiation point in a plate thickness direction of the composite material, and in accordance with movement of the irradiation point, the gas supply unit is configured to move a supply point where to supply the gas.

In the above configuration, in the gas supply unit, the supply point where to supply the gas can be moved in accordance with the movement the irradiation point. Accordingly, for example, when a thick composite material is cut or the like and even when the irradiation point is moved in the plate thickness direction of the composite material, the gas can be accurately supplied to the irradiation point. Therefore, the composite material can be suitably processed.

Further, a composite material processing method according to one aspect of the present disclosure is a composite material processing method for applying processing to a composite material (1) in which fibers and a resin are compounded and includes: an irradiation step of, by an irradiation unit (12), irradiating a front face (1a) of the composite material with a laser beam (L); and an ejection step of, by a first ejection unit (13A) and a second ejection unit (13B) arranged above the first ejection unit, ejecting a gas (G) to an area at or near an irradiation point (P) that is a point irradiated with the laser beam by the irradiation unit. An angle (θ1) between a direction in which the first ejection unit ejects the gas and the front face of the composite material differs from an angle (θ2) between a direction in which the second ejection unit ejects the gas and the front face of the composite material.

### LIST OF REFERENCES

1: composite material
1a: front face
1b: back face
10: processing apparatus
11: laser oscillator
12: laser head (irradiation unit)
13: assist gas supply unit (gas supply unit)
13A: first nozzle (first ejection unit)
13B: second nozzle (second ejection unit)
14: assist gas source
15: assist gas pipe
15A: first assist gas pipe
15B: second assist gas pipe
20: flat nozzle
21: opening
22: cylindrical part
30: flat nozzle
31: opening
32: cylindrical part

What is claimed is:

1. A composite material processing apparatus for cutting, along a planned cut line, a composite material in which fibers and a resin are compounded, the composite material processing apparatus comprising:
an irradiation unit configured to irradiate a front face of the composite material with a laser beam; and
a gas supply unit configured to supply a gas to an irradiation point that is a point irradiated with the laser beam by the irradiation unit,
wherein the gas supply unit has a first ejection unit configured to eject the gas to an area at or near the irradiation point and a second ejection unit configured to eject the gas to an area at or near the irradiation point and arranged above the first ejection unit, and
wherein an angle between a direction in which the first ejection unit ejects the gas and the front face of the composite material differs from an angle between a direction in which the second ejection unit ejects the gas and the front face of the composite material, and
wherein the first ejection unit and/or the second ejection unit ejects the gas to a region extending along the planned cut line.

2. The composite material processing apparatus according to claim 1 further comprising a third ejection unit configured to eject the gas to an area at or near the irradiation point and arranged above the second ejection unit,
wherein the third ejection unit ejects the gas in a direction inclined with respect to a horizontal plane, and
wherein an angle between a direction in which the third ejection unit ejects the gas and the horizontal plane differs from angles between directions in which the first ejection unit and the second ejection unit eject the gas and the horizontal plane.

3. The composite material processing apparatus according to claim 1, wherein the gas ejected from the first ejection unit and/or the second ejection unit is an inert gas.

4. The composite material processing apparatus according to claim 1, wherein the first ejection unit and the second ejection unit are arranged in the same quadrant about the irradiation point in plan view of the composite material.

5. The composite material processing apparatus according to claim 1,
wherein the irradiation unit is configured to move the irradiation point in a plate thickness direction of the composite material, and
wherein, in accordance with movement of the irradiation point, the gas supply unit is configured to move a supply point where to supply the gas.

6. A composite material processing method for applying processing to a composite material in which fibers and a resin are compounded, the composite material processing method comprising:
by an irradiation unit, irradiating a front face of the composite material with a laser beam; and
by a first ejection unit and a second ejection unit arranged above the first ejection unit, ejecting a gas to an area at or near an irradiation point that is a point irradiated with the laser beam by the irradiation unit,
wherein an angle between a direction in which the first ejection unit ejects the gas and the front face of the composite material differs from an angle between a direction in which the second ejection unit ejects the gas and the front face of the composite material.
